(19) United States
(12) Patent Application Publication
(10) Pub. No.: US 2003/0055752 A1
(43) Pub. Date: Mar. 20, 2003

(54) System and method for inventory assessment

(76) Inventor: Peter A. Thayer, Noblesville, IN (US)

Correspondence Address: BAKER BOTTS L.L.P., 2001 ROSS AVENUE, SUITE 600, DALLAS, TX, 75201-2980, US

(21) Appl. No.: 09/955,799

(22) Filed: Sep. 18, 2001

(51) Int. Cl. G06F 17/60

(52) U.S. Cl. 705/28; 705/1

(57) ABSTRACT

A system and method for inventory assessment include the capability to generate an enumeration query, transmit the enumeration query, and monitor messages associated with the enumeration query, wherein at least one of the messages may include data regarding an inventory object beyond the broadcast range of the transmission.

### TECHNICAL FIELD OF THE INVENTION

This invention relates generally to inventory management and, more particularly, to a system and method for inventory assessment.

### BACKGROUND OF THE INVENTION

Businesses require accurate assessments of their inventory for a variety of reasons. For example, a business may need to know how many items it currently has in stock so that it does not sell an item to a customer when one is not in stock or so that it can maintain an adequate supply. As another example, a business may need to know how many items it has in stock at different times so that it can make economic forecasts based on the rate at which items are selling. As an additional example, a business may need to locate a particular item so that it may be provided to a customer.

Typical systems and methods for assessing inventory involve substantial human interaction. For example, if a business wants to know how many items it has in its inventory, it may have someone count them. As another example, the business may have an employee make a log, in either manual or computerized form, of items as they arrive and depart. Thus, an employee may consult the log to determine the number of items in the inventory. Furthermore, the log may direct the employee to an item.

Unfortunately, having substantial human interaction may lead to several problems. For example, humans may make errors in counting items. As another example, logs are not always accurate because someone may forget to enter an item into a log upon its arrival or forget to delete an item from a log upon its departure. Furthermore, someone may intentionally circumvent the log for deceitful purposes. Thus, inaccurate inventory assessments may result. Additionally, having substantial human interaction may require increased labor costs and may be time consuming, especially if data is to be obtained about each item during the inventory assessment.

### SUMMARY OF THE INVENTION

The present invention provides systems and methods that substantially reduce or eliminate at least some of the disadvantages associated with previous systems and methods for inventory assessment. Accordingly, in at least certain embodiments, the present invention provides a system and method that assesses inventory quickly and accurately.

In particular embodiments, a system for inventory assessment includes a communication device capable of being associated with an inventory object. The communication device includes a transceiver, a memory, and a processor. The transceiver is operable to transmit and receive messages. The memory is coupled to the transceiver and is operable to store data in the messages. The processor is coupled to the memory and is operable to generate an enumeration query, to facilitate the transmission of the enumeration query by the transceiver, and to monitor messages associated with the enumeration query, wherein at least one of the messages may include data regarding an inventory object beyond the broadcast range of the transceiver.

In certain embodiments, a method for inventory assessment includes generating an enumeration query and transmitting the enumeration query. The method also includes monitoring messages associated with the enumeration query, wherein at least one of the messages may include data regarding an inventory object beyond the broadcast range of the transmission.

The present invention has several technical advantages. For example, in particular embodiments, the present invention allows an inventory assessment to be conducted by an automated process. Thus, the inventory assessment may be conducted quickly and accurately. As another example, in certain embodiments, the present invention allows an inventory assessment to be conducted via short-range communication devices. Thus, the devices may use low amounts of power, which allows low power consumption and decreased risk of harmful radiation effects. As a further example, in some embodiments, the present invention allows for the inclusion of data about the inventory objects in the inventory assessment. Accordingly, not only may the business determine how many items are in the inventory, but also what type of items are in the inventory and/or which items are in the inventory. Of course, different embodiments may have none, one, some, or all of these technical advantages and/or additional technical advantages.

Other technical advantages will be readily apparent to those skilled in the art from the following figures, description, and claims.

### BRIEF DESCRIPTION OF THE DRAWINGS

The following figures provide a more complete understanding of the invention, especially when considered in light of the following written description, and its technical advantages:

FIG. 1 illustrates a system for inventory assessment in accordance with one embodiment of the present invention;

FIG. 2 illustrates one embodiment of a communication device for the system in FIG. 1;

FIG. 3A illustrates one embodiment of a message format for exchanging information between communication devices of the system in FIG. 1;

FIG. 3B illustrates one embodiment of enumeration data carried by the message format of FIG. 3A;

FIG. 4 is a flowchart illustrating the operation of a communication device that initiates an enumeration query for one embodiment of the present invention; and

FIG. 5 is a flowchart illustrating the operation of a communication device that responds to an enumeration query for one embodiment of the invention.

### DETAILED DESCRIPTION OF THE INVENTION

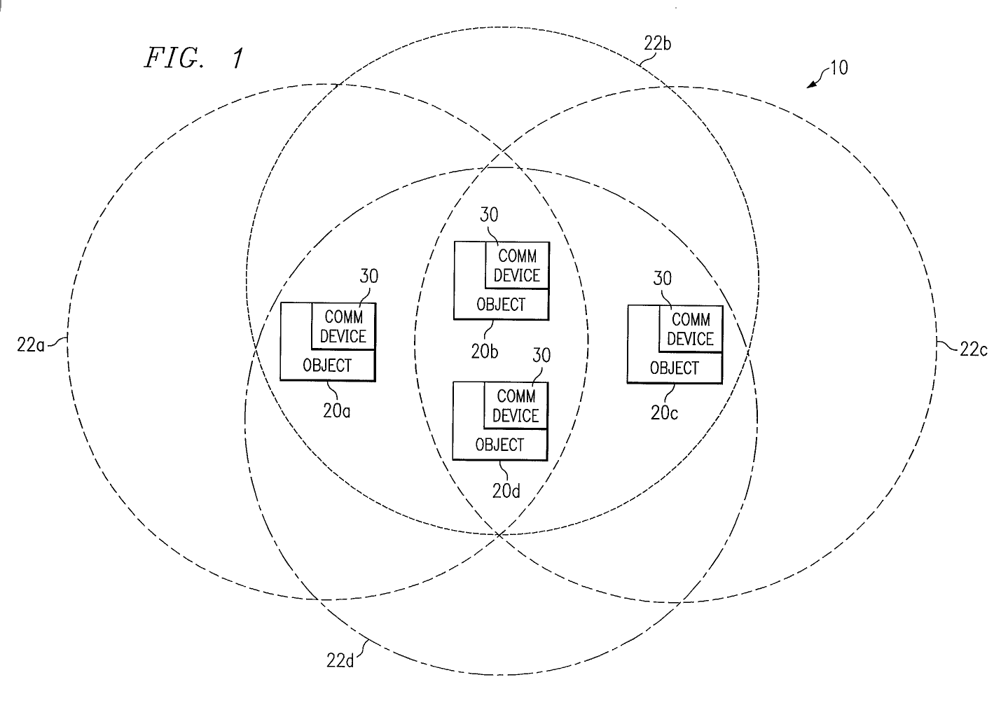

FIG. 1 illustrates a system 10 for inventory assessment in accordance with one embodiment of the present invention. In general, system 10 includes a variety of objects 20 that need to be inventoried. Each of objects 20 has an associated communication device 30 that is operable to communicate with communication devices 30 of neighboring objects 20, which allows an inventory to be taken of the objects 20.

In operation, when an inventory is to be taken of objects 20, communication device 30 of one of the objects transmits an enumeration query, which may be any type of message indicating that data about objects 20 is desired. The enumeration query is received by communication devices 30 of neighboring objects 20. The communication devices 30 of these objects 20 transmit an acknowledgment, which may be any type of message, to the communication device 30 of the object 20 from which the enumeration query was received and ignore other enumeration queries that are related to the enumeration query. The communication devices may perform the latter function by, for example, saving an identifier for the enumeration query and comparing the saved identifier against the identifier in subsequently received enumeration queries. The communication devices of these objects additionally retransmit the enumeration query, which is received by communication devices 30 of their neighboring objects 20. The communication devices 30 of these neighboring objects 20 also acknowledge the communication device 30 of the object 20 from which the enumeration query was received and ignore other enumeration queries that are related to the enumeration query. The communication devices of these third-level objects also retransmit the enumeration query, which is received by communication devices 30 of their neighboring objects 20. This process may continue until no new acknowledgments to the enumeration query are received.

The communication devices 30 of the lower-level objects 20 may then begin to report, via any type of message, to the communication devices 30 of higher-level objects 20 regarding the objects that acknowledged the enumeration query transmitted by the communication devices of the lower-level objects. Note that communication devices 30 of objects 20 at the periphery will receive no acknowledgments to their transmissions of the enumeration query. Because of this, these communication devices will expect no reports, so the devices, perhaps after a given period of time, may send reports regarding only their associated object. The data regarding the objects may be as simple as that they exist or may include more detailed information, such as, for example, the serial number, type, size, and/or location of the communication device and/or object. The communication devices 30 of higher-level objects 20 may then report regarding the lower-level communication devices and themselves to the communication devices 30 of the even higher-level objects 20. Finally, the data is relayed to the communication device 30 of the object 20 where the enumeration query initiated, and an inventory assessment may be made.

As an example of the process just described, assume that the enumeration query initiates at object 20a. Communication device 30 of object 20a would transmit the enumeration query, which would be received by communication devices within its neighborhood, represented by circle 22a. The enumeration query may contain an identifier for the enumeration query, so that communication devices receiving the enumeration query may determine if they have analyzed the enumeration query previously and/or may associate enumeration data with an enumeration query, and/or contain an identifier for the communication device, so that communication devices 30 receiving the enumeration query will know to which communication device 30 to respond. An identifier may be a combination of numbers, letters, numbers and letters, or any other form of indicator. The neighborhood may, for example, be the broadcast range of communication device 30. Note that the broadcast range could be affected by interference, receiver sensitivity, and receiver processing capabilities, as well as any of a variety of other factors.

As illustrated, communication device 30 of object 20b and communication device 30 of object 20d receive the enumeration query. Upon receipt, these communication devices transmit an acknowledgment of the enumeration query, which is received by communication device 30 of object 20a. The acknowledgment may indicate something as simple as that a communication device has received the enumeration query. In a particular embodiment, the communication devices may send an identifier (ID) for themselves and/or the associated object in the acknowledgment. Thus, it would be possible to determine which of communication devices 30 and/or objects 20 acknowledged the enumeration query. Various other data may also be included in the acknowledgement. In certain embodiments, when communication device 30 of object 20a receives the acknowledgments, it adds the communication devices to a list of communication devices from which it expects to receive an enumeration report. Communication device 30 of object 20a then expects to receive enumeration reports from all of the devices on the list before the enumeration query is complete. A timeout and error sequence may be used if a communication device acknowledges the enumeration query, but fails to send an enumeration report.

The communication devices 30 of object 20b and object 20d also retransmit the enumeration query to those objects in their neighborhoods, represented by circle 22b and circle 22d, respectively. The communication devices may also include an ID for themselves in the retransmitted enumeration query so that receiving communication devices will know to which communication device 30 to respond.

When the communication devices 30 of object 20b and object 20d retransmit the enumeration query in the illustrated embodiment, the query from each is received by the communication devices of all of the other objects. Thus, object 20a will receive an enumeration query from object 20b and object 20d. Upon receipt, the communication device 30 of object 20a discerns that the enumeration query is one that it has previously processed and, thus, does not respond to it, which may help avoid loops and reduce message traffic. In a particular embodiment, communication device 30 of object 20a makes this determination by examining an ID for the enumeration query, which the transmitting communication devices included in the retransmitted enumeration query.

Additionally, the communication device 30 of object 20b will receive the enumeration query from the communication device 30 of object 20d, and the communication device 30 of object 20d will receive the enumeration query from the communication device 30 of object 20b. The communication devices of these objects also discern that the received enumeration query is one that they have previously processed. The communication devices may make this determination by examining an ID for the enumeration query, which the other included in the retransmitted enumeration query. The communication devices may then decide not to respond to the enumeration query.

Furthermore, the communication device 30 of object 20c will receive the enumeration query from the communication device 30 of object 20b and the enumeration query from the communication device 30 of object 20d. The communication device 30 of object 20c may choose which of the enumeration queries to acknowledge. In certain embodiments, the communication device will respond the enumeration query received first and ignore the second, although other ordering or priority schemes may be implemented.

For illustrative purposes, assume the communication device 30 of object 20d decides to respond to the enumeration query from the communication device 30 of object 20b. Accordingly, communication device 30 of object 20d will receive no acknowledgment of its transmission of the enumeration query. This communication device may then report the inventory data for object 20d to communication device 30 of object 20a. Upon receipt of the enumeration query from the communication device 30 of object 20b, communication device 30 of object 20c acknowledges the enumeration query and retransmits the enumeration query to the objects 20 within its neighborhood, represented by circle 22c. As illustrated, object 20b and object 20d are within the neighborhood of this communication device. Thus, the communication devices 30 of object 20b and object 20d will receive the enumeration query transmitted by the communication device 30 of object 20c, discern that the enumeration query is one that they have previously processed, and send no acknowledgement. Accordingly, in the example, communication device 30 of object 20c will receive no acknowledgments to its transmission of the enumeration query.

Upon determining that no acknowledgments are forthcoming, the communication device 30 of object 20c may report the inventory data for object 20c to the communication device to which it transmitted the acknowledgment, communication device 30 of object 20b in this example. Note that communication device 30 of object 20b will be expecting to receive a report from communication device 30 of object 20c because an acknowledgment was received from it. Once communication device 30 of object 20b receives the data, the communication device may report it along with the inventory data for object 20b to communication device 30 of object 20a. Communication device 30 of object 20a may store this data along with the data received from communication device 30 of object 20d for processing by the communication device or another device.

As discussed, system 10 has several technical advantages. For example, system 10 uses automated devices to conduct the inventory assessment. This allows the inventory assessment to be conducted quickly and accurately. In certain instances, an inventory assessment may be conducted in only a manner of seconds. Moreover, inventory assessments may be conducted at programmed times. As another example, system 10 allows an enumeration query to gather inventory data regarding objects that are not within the neighborhood of the object where the enumeration query initiated. Thus, system 10 allows an inventory assessment to be performed with communication devices having a broadcast range that does not reach all of the objects in the inventory. As an example, Bluetooth™ compliant devices are supposed to have a broadcast range of approximately thirty feet, which would not reach all of the objects in a large warehouse. Accordingly, the communication devices may use a relatively low power, which is beneficial if objects 20 or communication devices 30 have limited capability to generate electrical power or are susceptible to radio frequency degradation. As a further example, by knowing whether an enumeration query has been previously processed and refusing to respond to previously processed enumeration queries, system 10 avoids loops and reduces message traffic.

The items in system 10 may have a variety of forms. Objects 20 may be vehicles, products, people, and/or any other type of physical entity. For example, system 10 is thought to be useful in taking inventories of automobiles in parking lots. In particular embodiments, objects 20 may themselves have processing capabilities and, hence, be able to perform any of a variety of functions, such as, for example, performing some or all of the tasks of one of communication devices 30 and/or assessing the inventory based on the data received in response to the enumeration query. Additionally, communication devices 30 may be radio frequency (RF) communication devices, infrared (IR) communication devices, or any other type of wireless communication devices. In a particular embodiment, communication devices 30 are Bluetooth™ compliant devices. Communication devices 30 may be compliant with wireless local-area network (LAN) protocols too, such as, for example, I.E.E.E. 802.11, HiperLAN, or HomeRF. Communication devices 30 may be attached to, connected to, coupled to, near, or otherwise associated with objects 20.

In certain embodiments, the communication device that initiates the enumeration query does not have to be associated with one of objects 20. For example, the initiating communication device may be associated with a computer that performs accounting functions. As another example, the initiating communication device may be coupled to a data network, such as the Internet, a LAN, or any other type of system from sending data from one computer to another, so that the inventory assessment may be initiated remotely from the inventory.

In particular embodiments, the communication devices may, by hardware and/or software, be dedicated initiators of or responders to enumeration queries. For example, a warehouse may only need, or preferably desire, one communication device capable of initiating an enumeration query. Thus, the communication devices associated with the objects may only respond to enumeration queries.

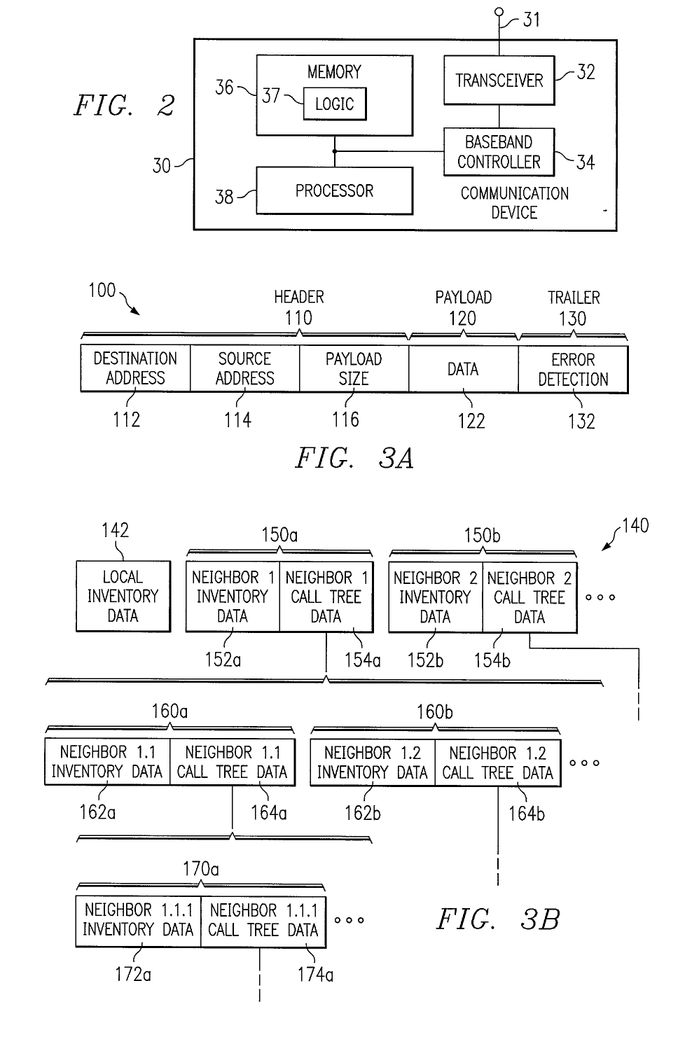

FIG. 2 illustrates one embodiment of a communication device 30 for system 10. As illustrated, communication device 30 includes an antenna 31, a transceiver 32, a baseband controller 34, a memory 36, and a processor 38. Antenna 31 is operable to receive electromagnetic signals and feed them to transceiver 32. Transceiver 32 is operable to extract information in the signals and convey the information to baseband controller 34. In a particular embodiment, transceiver 32 performs this by removing a carrier frequency from the signals. Baseband controller 34 is operable to convert the information in the signals into a format that is acceptable to memory 36 and processor 38. The information may then be stored in memory 36 and manipulated by processor 38. For example, processor 38 may determine that the information is an enumeration query, whether an enumeration query has been analyzed previously, and/or whether an acknowledgment is received in response to an enumeration query. Processor 38 may perform these operations according to a set of logic 37 in memory 36.

Conversely, when data is to be sent from communication device 30 to another communication device, processor 38 converts the information in memory 36 into the appropriate format for baseband controller 34. For example, processor 38 may generate an acknowledgment, facilitate the retransmission of an enumeration query, and/or generate a message containing data from neighboring communication devices, if any. Baseband controller 34 then converts the information into the appropriate format for wireless transmission, such as, for example, by determining a modulation sequence based on the information. Based on the converted message, transceiver 32 transmits electromagnetic signals representing the converted message using antenna 31, such as, for example, by inserting the information onto a carrier frequency.

The components of communication device 30 may have a variety of different forms. For example, processor 38 may be a reduced instruction set computer (RISC), a complex instruction set computer (CISC), an application specific integrated circuit (ASIC), a biological computer, an atomic computer, or any other type of device for manipulating information. Memory 36 may be random access memory (RAM), read-only memory (ROM), erasable programmable read-only memory (EPROM), compact disk read-only memory (CDROM), and/or any other type of volatile or nonvolatile electromagnetic or optical information storage device. Logic 37 may be entirely encoded in memory 36, partially encoded in processor 38, entirely encoded in processor 38, and/or encoded in any other appropriate media. Antenna 31, transceiver 32, and baseband controller 34 may be any type of device that can receive information from processor 38 and/or memory 36 and transmit electromagnetic signals based on the information. For embodiments in which communication device 30 is Bluetooth™ enabled, baseband controller 34 typically implements the bottom layers of the Bluetooth™ stack, such as, for example, L2CAP. In a particular embodiment, antenna 31, transceiver 32, and baseband controller 34 are part of an ROK 101 007/1 manufactured by Ericsson.

FIG. 3A illustrates one embodiment of a message format 100 for exchanging data between communication devices 30. Message format 100 includes a header section 110, a payload section 120, and a trailer section 130. Header section 110 includes a destination address field 112, a source address field 114, and a payload size field 116. Destination address field 112 contains the address of the communication device 30 to which the message is being sent. Source address field 114 contains the address of the communication device 30 that is sending the message. Payload size field 116 contains the size of payload section 120. Payload section 120 includes a data field 122. Data field 122 contains the data to be conveyed between the communication devices. For example, data field 122 may contain an enumeration query, an acknowledgment, or an enumeration report. Trailer section 130 includes an error detection field 132. Error detection field 132 contains data that allows determining whether errors have occurred in the transmission of the message, such as, for example, a parity bit or a check sum.

Payload section 120 may itself have a variety of fields. For example, payload section 120 may have a field that indicates what type of enumeration message is contained in payload section 120—enumeration query, acknowledgment, or enumeration report. Also, payload section 120 may have a field for an identifier that indicates the enumeration query with which the message is associated. Additionally, payload section 120 may have a field for an identifier that indicates for which communication device the message is intended. Of course, payload section 120 may also have a field that contains general data.

Additionally, header section 110 and trailer section 130 may contain additional and/or different data. For example, error detection field 132 could be located in header section 110. As another example, header section 110 may include a field indicating what type of data is contained in payload section 120. As a further example, header section 110 may contain a field indicating the format of the data in payload section 120. As still a further example, header section 110 or trailer section 130 may include a time stamp. In general, any appropriate type of data may be included in header section 110 and trailer section 130.

FIG. 3B illustrates one embodiment of enumeration data 140 carried by the data field 122 of message format 100 for an enumeration report. As illustrated, enumeration data 140 includes inventory data 142, such as, for example, part number, color, serial number, size, and/or location, for the object of the communication device transmitting the enumeration report and data sets 150a-150b regarding neighboring objects, typically those that have acknowledged the enumeration query transmitted earlier by the communication device.

As illustrated, data set 150a contains data regarding one neighboring object, and data set 150b contains data regarding another neighboring object. The neighboring objects represented by data sets 150a-150b may be viewed as children of the communication device transmitting the enumeration report. Data set 150a contains inventory data 152a and call tree data 154a regarding the first neighboring object. Data set 150b contains inventory data 152b and call tree data 154b regarding the second neighboring object. Inventory data 152a and inventory data 152b may contain data similar to inventory data 142. Call tree data 154a and 154b contain data regarding the objects that acknowledged to enumeration queries transmitted by the first and second neighboring devices, respectively. These objects could be viewed as grandchildren of the communication device producing the enumeration report.

For example, call tree data 154a contains data regarding objects that are neighbors of the first neighbor. As illustrated, the first neighboring object contains at least two neighbors, represented by data sets 160a-160b. Each of these data sets also includes inventory data 162a-162b, respectively, for the objects and call tree data 164a-164b, respectively, for the objects.

The data in call tree data 164a is also illustrated. As shown, this data includes data for objects that are great-grandchildren of the object producing the enumeration report, represented by data set 170a. The data for the object includes inventory data 172a and corresponding call tree data 174a.

As can be seen, enumeration data 140 contains inventory data for the object of the communication device generating the enumeration report, inventory data for objects that are neighbors of this object, inventory data for objects that are neighbors of the neighboring objects, and so forth. In certain embodiments, each communication device in a system would generate an enumeration report with data similar to enumeration data 140 and transmit the enumeration report to the communication device that it earlier acknowledged. In this manner, the inventory data would be relayed to the communication device that initiated the enumeration query. Note that the amount of enumeration data would vary from device to device, with the communication devices closer to the communication device that initiated the enumeration query generally having more enumeration data than the communication devices further from the initiator. For communication devices at the periphery, the enumeration data may just be the inventory data for the associated object.

Note that enumeration data 140 may allow relationships between the objects in a system to be determined. For example, the relationship between the object producing the enumeration report, the objects that acknowledged it, the objects that acknowledged the objects that acknowledged it, and so forth may be determined. Furthermore, when enumeration data 140 is transmitted, the receiving communication device may incorporate the enumeration data with the data from other communication devices that acknowledged it. Suppose, for example, that the object producing the enumeration report is the third communication device to acknowledge the communication device that will receive the enumeration report. Thus, to the communication device that will receive the enumeration report, the object of the communication device producing the enumeration report will be neighbor 3, the object of the communication device associated with data set 150a will be neighbor 3.1, the object of the communication device associated with data set 150b will be neighbor 3.2, the object of the communication device associated with data set 160a will be neighbor 3.1.1, the object of the communication device associated with data set 160b will be neighbor 3.1.2, and the object of the communication device associated with data set 170a will be neighbor 3.1.1.1. Accordingly, a call tree structure may be produced from the enumeration query. The call tree structure may be useful in locating the objects and/or assessing system performance.

Although FIG. 3B illustrates one embodiment of the enumeration data for an enumeration report, a variety of other embodiments exist. For example, the enumeration data may actually include data for a demarcation system similar to that in enumeration data 140 for the communication devices. As another example, the enumeration data may be arranged in any of a variety of orders.

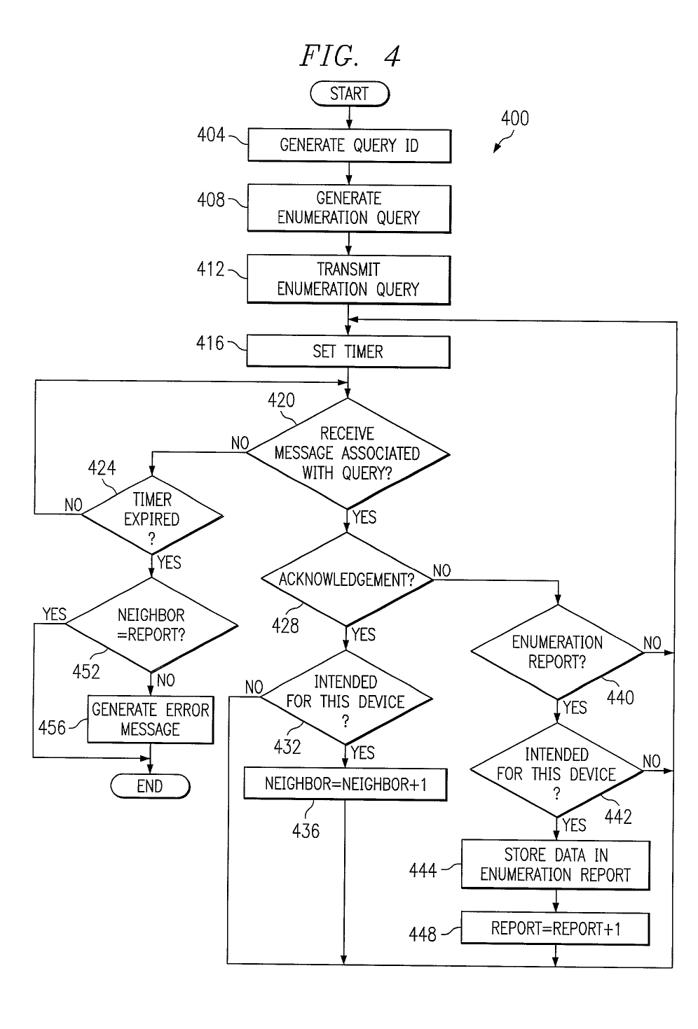

FIG. 4 is a flowchart 400 illustrating the operation of a communication device, such as, for example, communication device 30, that initiates an enumeration query for one embodiment of the invention. To begin an enumeration query, the communication device generates a query identifier (ID), which may be a unique identifier for the query, at function block 404. Then, the communication device generates an enumeration query at function block 408 and transmits the enumeration query at function block 412. The enumeration query may contain an ID for the communication device, so that the communication devices that receive the enumeration query will know where to respond, and/or any other appropriate data.

At function block 416, the communication device sets a timer. The communication device then determines whether it has received a message associated with the enumeration query at decision block 420. The communication device may determine this by examining an ID in the received messages, if any. In a particular embodiment, the ID is the query ID. If the communication device has not received a message associated with the enumeration query, the communication device determines whether the timer has expired at decision block 424. If the timer has not expired, the communication device returns to decision block 420. The communication device will continue to cycle between decision block 420 and decision block 424 until it receives a message associated with the enumeration query or the timer expires.

If the communication device receives a message associated with the enumeration query before the timer expires, the communication device determines whether the message is an acknowledgment of the enumeration query at decision block 428. If the message is an acknowledgment, the communication device determines whether the acknowledgment is intended for the communication device at decision block 432. The communication device performs this analysis to ensure that it is not processing an acknowledgment to the enumeration query that is directed to another communication device. The communication device may accomplish this by examining an identifier in the message that indicates the intended communication device for the message. If the acknowledgment is intended for the communication device, the communication device increments a variable storing the number of neighbors for the communication device at function block 436. The communication device then resets the timer at function block 416 and returns to cycling between decision block 420 and decision block 424. If, however, the acknowledgment is not intended for the communication device, the communication device again resets the timer at decision block 416 and returns to cycling between decision block 420 and decision block 424. The communication device resets the timer in this instance because the message indicates that there is activity regarding the enumeration query.

Returning to decision block 428, if the communication device decides that the message is not an acknowledgment, the communication device determines whether the message is an enumeration report at decision block 440. If the message is not an enumeration report, the communication device again resets the timer at function block 416 and returns to cycling between decision block 420 and decision block 424. If, however, the message is an enumeration report, the communication device determines whether the enumeration report is intended for the communication device at decision block 442. If the enumeration report is intended for the communication device, the communication device stores the data in the enumeration report at function block 444 and increments a variable representing the number of enumeration reports at function block 448. The communication device then resets the timer at function block 416 and returns to cycling between decision block 420 and decision block 424. If, however, the enumeration report is not intended for the communication device, the communication device also resets the timer at function block 416 and returns to cycling between decision block 420 and decision block 424.

Once the timer has expired, the communication device determines, at decision block 452, whether it has received enumeration reports from all of the communication devices that acknowledged the enumeration query. If the communication device has received enumeration reports from all of the communication devices that acknowledged the enumeration query, the process of gathering inventory data is at an end. If, however, the communication device has not received enumeration reports from all of the communication devices that acknowledged the enumeration query, an error has occurred, and the communication device generates an error message at function block 456. The process of gathering inventory data is then at an end.

Although a variety of operations have been discussed with respect to flowchart 400, other embodiments of the invention may have more, fewer, and/or different arrangements of operations. For example, a communication device may not reset the timer at function block 416 when a message is not intended for it. Thus, the communication device would reset the timer only when it receives a message intended for it. This may be beneficial in avoiding loops. As another example, the communication device may not check whether the message is intended for it at decision blocks 432 and 442. This may happen, for example, if message format 100 is used, because the information in the message may never be processed according to the operations illustrated by flowchart 400 since the address in destination address field 112 would not match the address of the communication device. As a further example, if the number of acknowledgments does not match the number of enumeration reports received, the communication device may reinitiate the enumeration query. As still a further example, the communication device may keep track of which devices acknowledged the enumeration query and which devices provided enumeration reports. Thus, the communication device may be able to pinpoint where problems are occurring in the system. Moreover, the communication device would not have to maintain a counter for the acknowledgments and/or enumeration reports, perhaps maintaining a list of those communication devices that have sent acknowledgements and/or reports or perhaps maintaining nothing. As still another example, the communication device may be able to analyze messages to determine whether loops are occurring. The communication device may do this by, for example, comparing a received message against previously received messages to determine whether the message has been received previously. Additionally, it will be understood that flowchart 400 could readily be expressed as a state diagram.

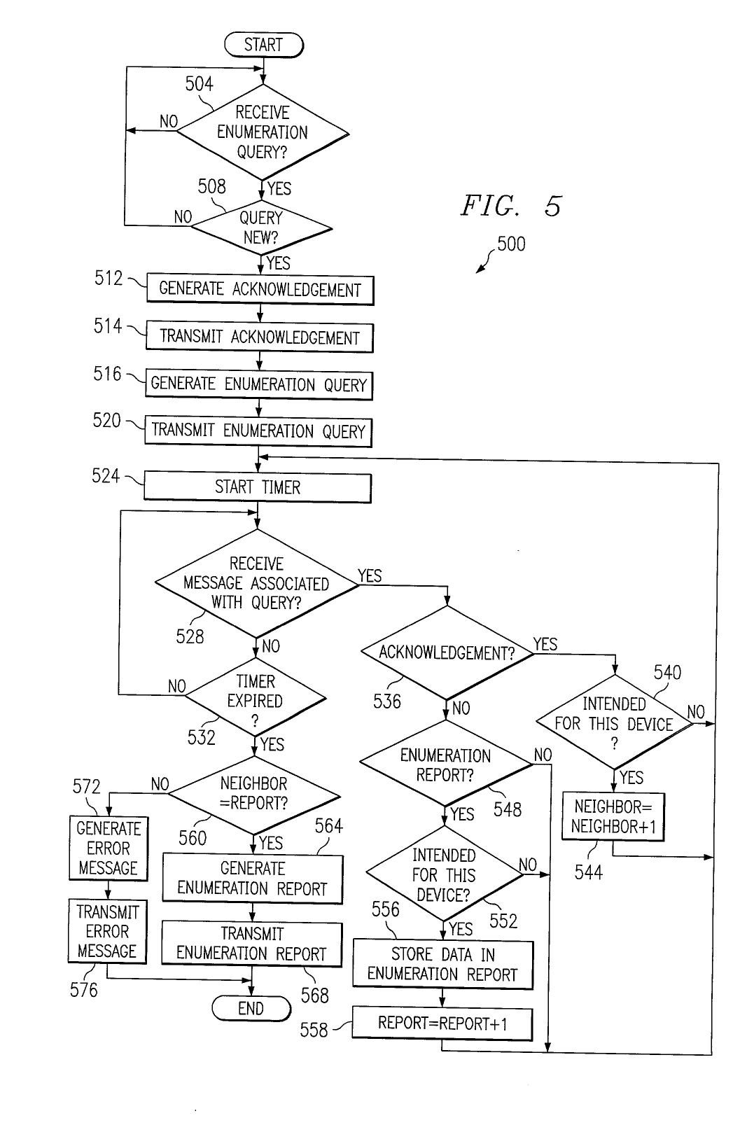

FIG. 5 is a flowchart 500 illustrating the operation of a communication device, such as, for example, communication device 30, that responds to an enumeration query for one embodiment of the invention. At decision block 504, the communication device determines whether it has received an enumeration query. If the communication device has not received an enumeration query, the communication device waits to receive an enumeration query at decision block 504. Upon receiving the enumeration query, the communication device determines, at decision block 508, whether it has processed the enumeration query previously. For example, the communication device may accomplish this by examining an ID in the message. If the communication device has processed the query previously, the communication device returns to decision block 504. If, however, the communication device has not processed the query previously, the communication device generates an acknowledgment message at function block 512. The acknowledgment may include an ID for the enumeration query, an ID for the communication device, data about the associated object, and/or any other appropriate data. The communication device transmits the message at function block 514. At function block 516, the communication device generates an enumeration query based on the received enumeration query. The generated enumeration query may contain an ID for the received enumeration query, an ID for the communication device, so that any communication device receiving the enumeration query will know where to respond, and/or any other appropriate data. The communication device transmits the generated enumeration query at function block 520.

At function block 524, the communication device starts a timer. The communication device then determines whether it has received a message associated with the enumeration query at decision block 528. The communication device may, for example, examine an ID in a message to make this determination. If the communication device has not received a message associated with the query, the communication device checks whether the timer has expired at decision block 532. If the timer has not expired, the communication device returns to decision block 528. The communication device will continue to cycle between decision block 528 and decision block 532 until it receives a message associated with the enumeration query or the timer expires.

If the communication device receives a message associated with the enumeration query before the timer expires, the communication device determines, at decision block 536, whether the message is an acknowledgment. If the message is an acknowledgment, the communication device determines whether the acknowledgment is intended for the communication device at decision block 540. The communication device performs this operation to ensure that the acknowledgment is not intended for a neighboring communication device and may accomplish this by, for example, examining an ID in the message. If the message is not intended for the communication device, the communication device resets the timer at function block 524 and again begins to cycle between decision block 528 and decision block 532. If, however, the message is intended for the communication device, the communication device increments a variable indicating the number of communication devices that have acknowledged the enumeration query at function block 544. The communication device then resets the timer at function block 524 and returns to cycling between decision block 528 and decision block 532.

Returning to decision block 536, if the communication device determines that the message is not an acknowledgment, the communication device determines whether the message is an enumeration report at decision block 548. If the message is not an enumeration report, the communication device resets the timer at function block 524 and again returns to cycling between decision block 528 and decision block 532. If, however, the message is an enumeration report, the communication device determines whether the enumeration report is intended for the communication device at decision block 552. The communication device performs this operation to ensure that the enumeration report is not intended for a neighboring communication device and may accomplish this by, for example, examining an ID in the message. If the enumeration report is not intended for communication device, the communication device resets the timer at function block 524 and returns to cycling between decision block 528 and decision block 532. If, however, the enumeration report is intended for the communication device, the communication device stores the data in the enumeration report at function block 556, resets the timer at function block 524, and returns to cycling between decision block 528 and discussion block 532.

Returning to decision block 532, once the timer expires, the communication device determines, at decision block 560, whether it has received enumeration reports from all of the communication devices that acknowledged the enumeration query. Note that the number of communication devices acknowledging the enumeration query may not be the actual number of neighboring communication devices because a communication device may, in some embodiments, only acknowledge one enumeration query. If the communication device has received enumeration reports from all of the communication devices that acknowledged the enumeration query, the communication device itself generates an enumeration report at function block 564. The enumeration report may include the data in the enumeration reports from the other communication devices. The communication device then transmits this enumeration report at function block 568 and the process comes to an end. If, however, the communication device has not received enumeration reports from all of the communication devices that acknowledged the enumeration query, the communication device generates an error message at function block 572 and transmits the error message at function block 576. The process then comes to an end.

Although flowchart 500 illustrates a variety of operations for a communication device, in other embodiments, a communication device may have more, less, and/or a different arrangement of operations. For example, a communication device may not reset the timer if a message is not intended for the communication device. As another example, the communication device may not check whether the message is intended for it at decision blocks 540 and 552. This may happen, for example, if message format 100 is used, because the message may be ignored since the destination address does not match the address of the communication device. As a further example, the communication device may reinitiate the enumeration query if it has not received reports from all of the communication devices that acknowledged the enumeration query. As still a further example, the communication device may send the data received in the enumeration reports along with the error message generated at function block 572. As still another example, the communication device may be able to analyze messages to determine whether loops are occurring. As another example, the communication device may not generate and transmit an acknowledgment. This could happen, for example, if the device used only a timer in determining if the enumeration query was complete. Additionally, it will be readily understood that flowchart 500 could be expressed as a state diagram.

In particular embodiments, the data collected and transmitted by the lower-level communication devices may contain data that allows the upper-level devices to determine relationships between the communication devices. For example, an intermediate-level communication device might include data that would allow an upper-level device to determine which communication devices responded to which communication device. This could be useful in determining geographic locations of communication devices.

In certain embodiments, communication devices could acknowledge enumeration queries from multiple communication devices, which would allow relationships between the objects to be determined. This could also aid in locating a communication device. For example, if communication device 30 of object 20c in FIG. 1 were to acknowledge an enumeration query from communication device 30 of object 20b and communication device 30 of object 20d, then it would be known that the communication device is within the area of overlap of circle 22b and circle 22d. Furthermore, if the fact that communication device 30 of object 20c does not respond to the enumeration query of communication device of object 20a is included, then it would be known that object 20c is not within the area where circle 22a, circle 22b, and circle 22d overlap. Other techniques, such as time delay of arrival, could also be used for locating objects.

Although a variety of embodiments have been discussed with respect to the present invention, a variety of additions, deletions, substitutions, and transformations will be readily suggested to those skilled in the art. Accordingly, the following claims are meant to cover such additions, deletions, substitutions, and transformations.

What is claimed is:

1. A system for inventory assessment, comprising:
a communication device capable of being associated with an inventory object, the communication device comprising:
a transceiver operable to transmit and receive messages;
a memory coupled to the transceiver, the memory operable to store data in the messages; and
a processor coupled to the memory, the processor operable to generate an enumeration query, to facilitate the transmission of the enumeration query by the transceiver, and to monitor messages associated with the enumeration query, wherein at least one of the messages may include data regarding an inventory object beyond the broadcast range of the transceiver.

2. The system of claim 1, wherein the processor is further operable to determine an identifier for the enumeration query and to include this identifier in the enumeration query.

3. The system of claim 1, wherein the processor is further operable to:
receive an enumeration query;
determine whether the enumeration query has been received previously; and
generate a message acknowledging the enumeration query if the enumeration query has not been received previously.

4. The system of claim 1, wherein the processor is further operable to include an identifier for the communication device in the enumeration query.

5. The system of claim 1, wherein the processor is further operable to determine the number of messages acknowledging the enumeration query.

6. The system of claim 1, wherein:
the processor is further operable to receive messages containing enumeration data; and
the memory is operable to store the enumeration data.

7. The system of claim 6, wherein the processor is further operable to generate a message containing the enumeration data.

8. The system of claim 6, wherein the enumeration data indicates a relationship between inventory objects.

9. The system of claim 1, wherein at least one of the messages associated with the enumeration query includes data about an inventory object.

10. The system of claim 1, wherein the broadcast range of the transceiver is approximately thirty feet.

11. A system for inventory assessment, comprising:
a communication device capable of being associated with an inventory object, the communication device comprising:
means for transmitting and receiving messages;
means for storing data in the messages;
means for generating an enumeration query and facilitating the transmission of the enumeration query; and
means for monitoring messages associated with the enumeration query, wherein at least one of the messages may include data regarding an inventory object beyond the broadcast range of the means for transmitting and receiving.

12. The system of claim 11, further comprising:
means for determining an identifier for the enumeration query; and
means for including this identifier in the enumeration query.

13. The system of claim 11, further comprising:
means for receiving an enumeration query;
means for determining whether the enumeration query has been received previously; and
means for generating a message acknowledging the enumeration query if the enumeration query has not been received previously.

14. The system of claim 11, further comprising means for including an identifier for the communication device in the enumeration query.

15. The system of claim 11, further comprising means for determining the number of messages acknowledging the enumeration query.

16. The system of claim 11, further comprising:
means for receiving messages containing enumeration data; and
means for storing the enumeration data.

17. The system of claim 16, further comprising means for generating a message containing the enumeration data.

18. The system of claim 16, wherein the enumeration data indicates a relationship between inventory objects.

19. The system of claim 11, wherein at least one of the messages associated with the enumeration query includes data about an inventory object.

20. The system of claim 11, wherein the broadcast range of the means for transmitting and receiving is approximately thirty feet.

21. A set of logic encoded in media, the logic operable to assist in inventory assessment by accomplishing the following operations:
generate an enumeration query;
facilitate the transmission of the enumeration query; and
monitor messages associated with the enumeration query, wherein at least one of the messages may include data regarding an inventory object beyond the broadcast range of the transmission.

22. The logic of claim 21, wherein the logic is further operable to determine an identifier for the enumeration query and to include this identifier in the enumeration query.

23. The logic of claim 21, wherein the logic is further operable to determine whether messages are associated with the enumeration query.

24. The logic of claim 21, wherein the logic is further operable to:
receive an enumeration query;
determine whether the enumeration query has been received previously; and
generate a message acknowledging the enumeration query if the enumeration query has not been received previously.

25. The logic of claim 21, wherein the logic is further operable to include an identifier associated with the logic in the enumeration query.

26. The logic of claim 21, wherein the logic is further operable to determine the number of messages acknowledging the enumeration query.

27. The logic of claim 21, wherein the logic is further operable to:
receive messages containing enumeration data; and
store the enumeration data.

28. The logic of claim 27, wherein the logic is further operable to generate a message containing the enumeration data.

29. The logic of claim 27, wherein the enumeration data indicates a relationship between inventory objects.

30. The logic of claim 21, wherein at least one of the messages associated with the enumeration query includes data about an inventory object.

31. A method for inventory assessment, comprising:
generating an enumeration query;
transmitting the enumeration query;
monitoring messages associated with the enumeration query, wherein at least one of the messages may include data regarding an inventory object beyond the broadcast range of the transmission.

32. The method of claim 31, further comprising:
determining an identifier for the enumeration query; and
including this identifier in the enumeration query.

33. The method of claim 31, further comprising:
receiving an enumeration query;
determining whether the enumeration query has been received previously; and
generating a message acknowledging the enumeration query if the enumeration query has not been received previously.

34. The method of claim 31, further comprising including an identifier for the communication device in the enumeration query.

35. The method of claim 31, further comprising determining the number of messages acknowledging the enumeration query.

36. The method of claim 31, further comprising:
receiving messages containing enumeration data; and
storing the enumeration data.

37. The method of claim 36, further comprising generating a message containing the enumeration data.

38. The method of claim 36, wherein the enumeration data indicates a relationship between inventory objects.

39. The method of claim 31, wherein at least one of the messages associated with the enumeration query includes data about an inventory object.

40. The method of claim 31, wherein the broadcast range of the transmission is approximately thirty feet.

41. A system for inventory assessment, comprising:
a communication device capable of being associated with an inventory object, the communication device comprising:
a transceiver operable to transmit and receive messages;
a memory coupled to the transceiver, the memory operable to store data in the messages; and
a processor coupled to the memory, the processor operable to:
generate an enumeration query including an identifier for the communication device;
facilitate the transmission of the enumeration query by the transceiver;
detect the receipt of messages associated with the enumeration query;
determine the number of messages acknowledging the enumeration query; and
determine the number of messages containing enumeration data, wherein at least one of the messages may include data regarding an inventory object beyond the broadcast range of the transceiver.

42. The system of claim 41, wherein the processor is further operable to:
detect the receipt of an enumeration query;
determine whether the enumeration query has been received previously;
generate a message acknowledging the enumeration query if the enumeration query has not been received previously; and
generate a message containing the enumeration data.

43. The system of claim 41, wherein the enumeration data indicates a relationship between inventory objects.

44. The system of claim 41, wherein at least one of the messages associated with the enumeration query includes data about an inventory object.

45. The system of claim 41, wherein the broadcast range of the transceiver is approximately thirty feet.
